(19) United States
(12) Patent Application Publication
(10) Pub. No.: US 2017/0021757 A1
(43) Pub. Date: Jan. 26, 2017

(54) Tie Down Apparatus and Method for Vehicle Tailgate

(71) Applicant: Dennis L. Nutter, Oakdale, CA (US)

(72) Inventor: Dennis L. Nutter, Oakdale, CA (US)

(21) Appl. No.: 14/756,023

(22) Filed: Jul. 22, 2015

(51) Int. Cl. B60P 7/08; B62D 33/023; B60P 7/135

(52) U.S. Cl. CPC B60P 7/0823; B60P 7/135; B60P 7/0807; B62D 33/023

(57) ABSTRACT

A tie down assembly is removably mounted on the tailgate of a pickup truck when the tailgate is in a generally horizontally oriented deployed position. The tie down assembly includes an elongate anchor member extending from one end of the tailgate to the other end of the tailgate. First and second bracket assemblies are each mounted on a different one of the first and second ends of the elongate anchor member. Each of the bracket assemblies is shaped and dimensioned to engage detachably one of the tailgate latches such that the tailgate handle can be operated to release the first and second bracket assemblies from the tailgate latches.

This invention relates to apparatus for securing in place one or more objects.

More particularly, the invention relates to apparatus to secure in place one or more objects being transported on a vehicle.

Those of skill in the art have long endeavored to provide new and improved equipment and methodologies to secure objects during transport.

Accordingly, it would be advantageous to develop improved equipment and methodologies in connection with the same.

Therefore, it is a principal object of the invention to provide a new process and equipment to secure objects during transport.

This, and other and further objects of the invention will be apparent to those skilled in the art from the following detailed description thereof, taken in conjunction with the drawings, in which:

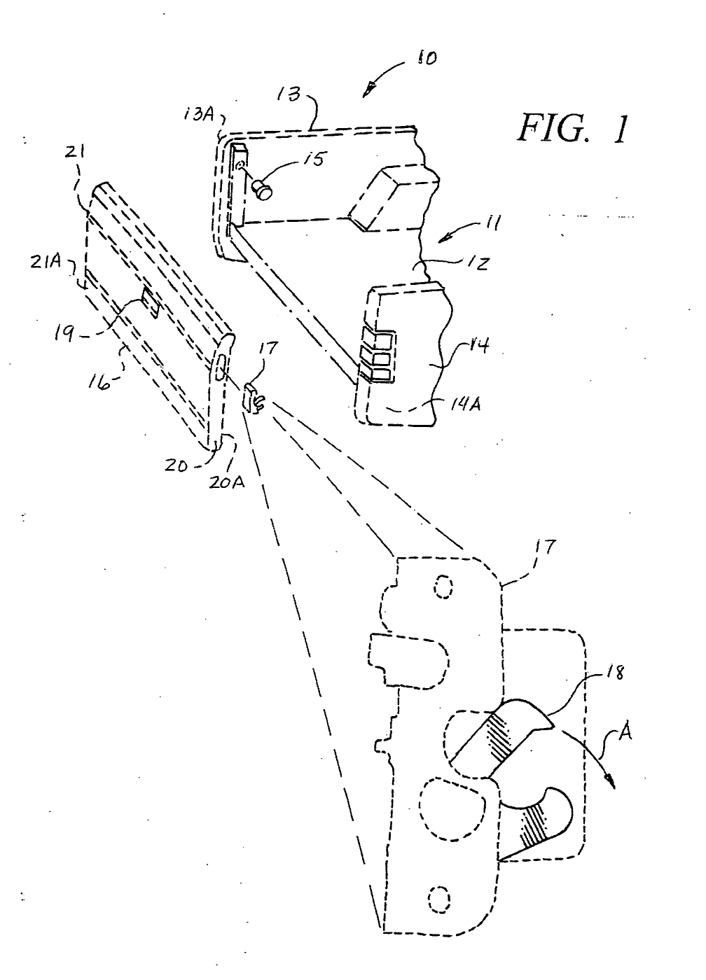

FIG. 1 is exploded view illustrating a conventional tailgate latching system for a pickup truck;

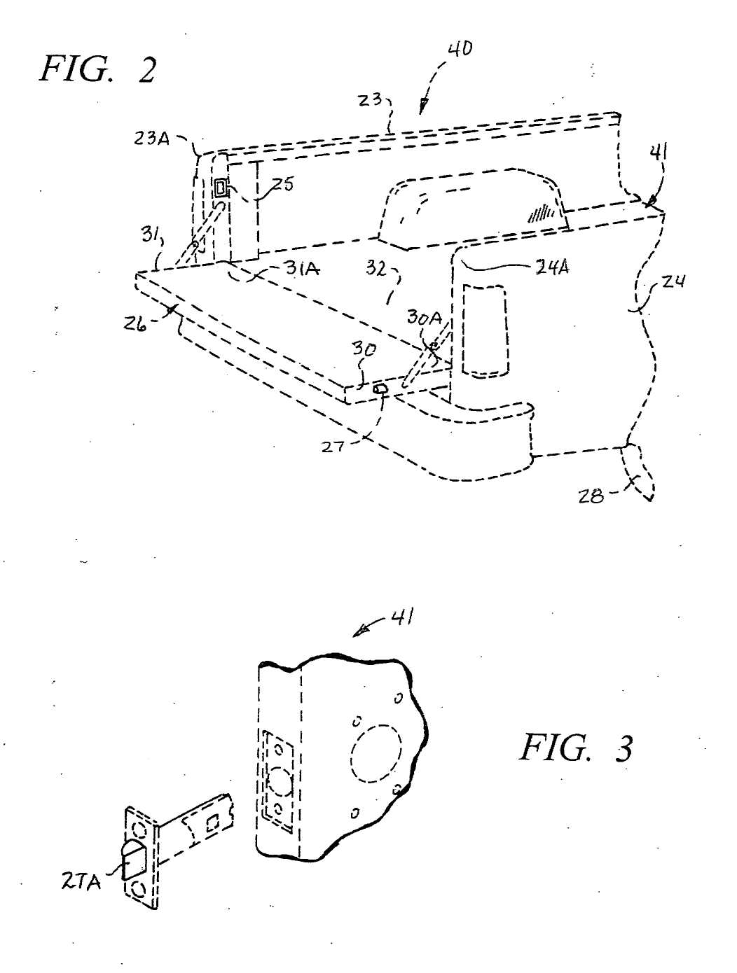

FIG. 2 is a perspective view illustrating another conventional tailgate latching system for a pickup truck;

FIG. 3 is a perspective view illustrating a conventional latching system for a door, which door latching system is generally similar in operation to the latching system in the tailgate of FIG. 2;

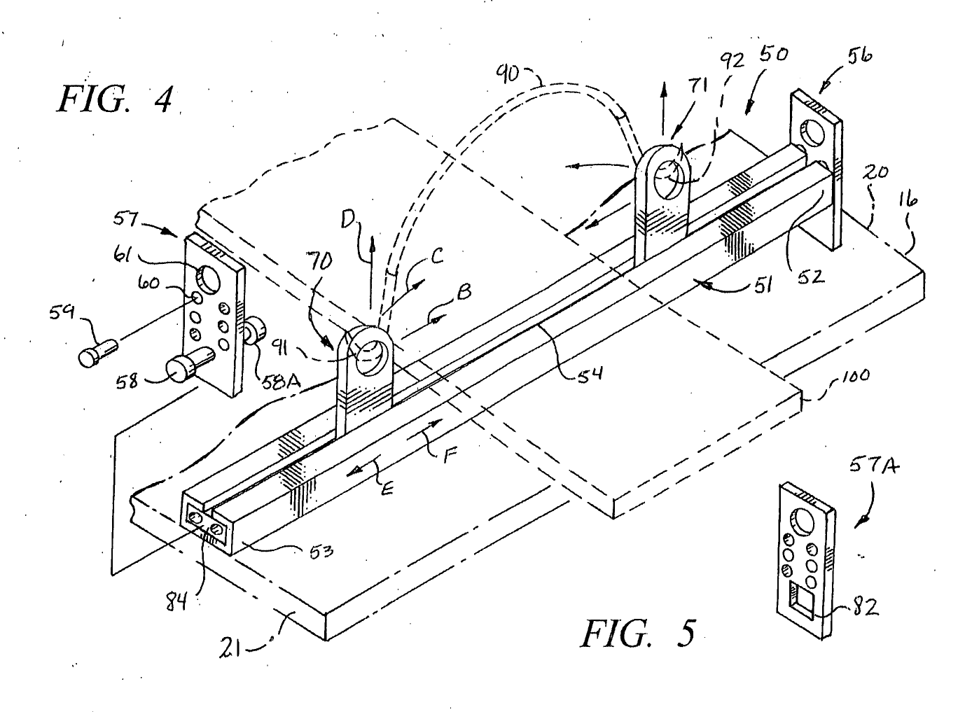

FIG. 4 is a perspective view illustrating a tie down assembly constructed in accordance with the invention to be detachably mounted on a tailgate of the type illustrated in FIG. 1;

FIG. 5 is a perspective view illustrating an alternate bracket assembly which can be utilized on the tie down assembly of FIG. 4 to adapt the tie down assembly to be detachably mounted on a tailgate of the type illustrated in FIG. 2;

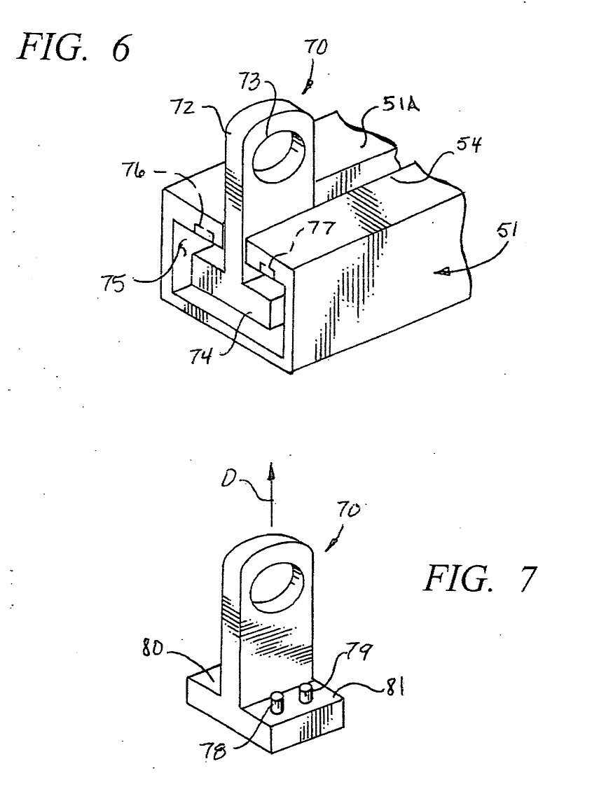

FIG. 6 is a perspective view illustrating a tie down anchor unit slidably mounted in the tie down assembly of FIG. 4;

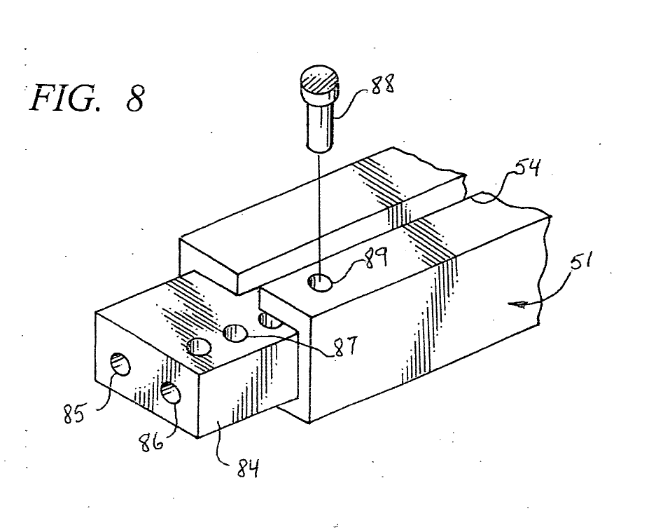

FIG. 7 is a perspective view illustrating the mode of operation of the tie down anchor unit depicted in FIG. 6; and,

FIG. 8 is a perspective view illustrating the mode of operation of a member slidably inserted in one end of the tie down assembly of FIG. 4 in order to provide a structure on which to mount a bracket assembly.

Briefly, provided are improvements in combination with a pickup truck. The pickup truck comprises a plurality of axles; four ground engaging tires mounted on the axles; a body; and, a suspension operatively associated with the axles and the body. The body includes a bed comprising a floor; a pair of spaced apart side walls upwardly extending from the floor and each having a distal end; a tailgate pivotally mounted on the bed and including a pair of spaced apart ends; a pair of latches each mounted on a different end of the tailgate and shaped and dimensioned to engage detachably a different one of the distal ends of the side walls; and, a handle mounted on the tailgate to disengage the latches from the distal ends of the side walls. The tailgate is movable between at least two operative positions, a first generally vertically oriented stowed position with the latches engaging the distal ends of the side walls; and, a second generally horizontally oriented deployed position with the latches disengaged from the distal ends of the side walls. In accordance with the invention, the improvements comprise a tie down assembly removably mounted on the tailgate when the tailgate is in the second generally horizontally oriented deployed position. The tie down assembly includes an elongate anchor member extending from one end of the tailgate to the other end of the tailgate. The anchor member includes a first end and a second end spaced apart from said first end. The tie down assembly also includes first and second bracket assemblies each mounted on a different one of the ends of the elongate anchor member. Each of the bracket assemblies is shaped and dimensioned to engage detachably one of the tailgate latches such that the tailgate handle can be operated to release the first and second bracket assemblies from the tailgate latches. The tie down assembly also includes tie down anchor units mounted on the elongate anchor member; and, at least one tie down extending from one tie down anchor unit to another tie down anchor unit.

Turning now to the drawings, which depict the presently preferred embodiments of the invention for purposes of illustrating the invention and not by way of limitation thereof, and in which like reference characters refer to corresponding elements throughout the several views, FIG. 1 is an exploded view illustrating portions of a pickup truck 10. Truck 10 includes, in conventional fashion, axles (not shown), four ground engaging wheels mounted on the axles (not shown—although a portion of such a wheel is illustrated in FIG. 2), a suspension (not shown), and a body including a bed 11. Bed 11 includes floor 12, a pair of spaced apart parallel side walls 13, 14 upwardly extending from said floor and each having a distal end 13A, 14A, respectively. Bed 11 also includes a tailgate 16 pivotally mounted on bed 11. Tailgate 16 includes a pair of spaced apart ends 20, 21. A pair of latches 17 each mounted on a different end 20, 21 of the tailgate 16 are shaped and dimensioned to engage detachably a different one of the distal ends 13A, 14A of the side walls 13, 14. A handle 19 mounted on the tailgate 16 is manually operable to disengage each of latches 17 from its respective distal end 13A, 14A of side walls 13, 14. In particular, each distal end 13A, 14A includes a pin 15 which is fixedly mounted on the distal end 13A, 14A and extends inwardly directly toward an equivalent pin which is fixedly mounted on the other opposing distal end 13A, 14A. Each latch 17 includes a jaw 18 which is pivotally mounted in the latch 17. When handle 19 is outwardly pulled or otherwise manually operated to the “open” position, jaw 18 is in the position illustrated in FIG. 1. When tailgate 16 is pivoted to an upright orientation comparable to that illustrated in FIG. 1, and when handle 19 is then released or otherwise manually operated to the “closed” position, jaw 18 is pivots downwardly in the direction of arrow A to engage and lock onto its operatively associated pin 15 mounted in the distal end of one of side walls 13, 14. Jaw 18 is subsequently disengaged or released from its associated pin 15 by once again manually pulling handle 19 to its “open” position.

Accordingly, as is evident from the foregoing, tailgate 16 is movable between at least two operative positions, a first generally vertically oriented stowed position with the jaws 18 engaging the pins 15 fixedly mounted in the distal ends 13A, 14A of the side walls 13 and 14, and, a second generally horizontally oriented deployed position with the jaws 18 disengaged from the pins 15.

The tailgate construction explained above and illustrated with respect to FIG. 1 is widely used and well known with respect to pickup trucks.

Another well known tailgate construction is illustrated in FIG. 2. In FIG. 2, pickup truck 40 includes, in conventional fashion, axles (not shown), four ground engaging wheels 28 mounted on the axles, a suspension (not shown), and a body including a bed 41. Bed 41 includes floor 32, a pair of spaced apart parallel side walls 23, 24 upwardly extending from floor 32 and each having a distal end 23A, 24A, respectively. Bed 41 also includes a tailgate 26 pivotally mounted on the bed 41. Tailgate 26 includes a pair of spaced apart ends 30, 31. A pair of latches 27 each mounted on a different end 30, 31 of the tailgate 26 are shaped and dimensioned to engage detachably a different one of the distal ends 23A, 24A of the side walls 23, 24. A handle (not visible) mounted on the tailgate 26 is manually operable to disengage each of latches 27 from its respective distal end 23A, 24A of side walls 23, 24. In particular, each distal end 23A, 24A includes an orthogonal opening 25 which is formed in the distal end 23A, 24A.

Each latch 27 operates in the same manner as the common door latch 27A illustrated in FIG. 3. In FIG. 3, latch 27A is in a deployed configuration which, when a door to a room is closed, permits latch 27A to extend into and engage the orthogonal opening in a latch plate (not shown). The orthogonal opening in a door latch plate is comparable to opening 25. The door to a room is opened by grasping and manually operating the door knob in order to retract latch 27A out of the orthogonal opening in the latch plate, after which the door can be pulled from a closed to an open position. Latch 27 is operated in a manner similar to that used to move latch 27A between a deployed and retracted position, except that a handle (not visible in FIG. 3) typically mounted in a position comparable to that of handle 19 (FIG. 1) is used to manually move latch 27 between a retracted position and the deployed position illustrated in FIG. 2. Accordingly, when the handle in tailgate 26 is outwardly pulled or otherwise manually operated to the “open” position, each latch 27 is retracted and tailgate can be freely moved from the horizontal orientation of FIG. 2 to a vertical orientation comparable to that illustrated in FIG. 1 for tailgate 16. After tailgate 26 is in a vertical orientation, the handle on tailgate 26 can be released, allowing the latches 27 each to extend into and engage its operatively associated opening 25 to lock the tailgate 26 in a vertically oriented position. Latches 27 are subsequently disengaged or retracted from openings 25 by once again manually pulling handle 19 to its “open” position so that tailgate 26 may be lowered from a vertical orientation to the horizontal orientation illustrated in FIG. 2.

Accordingly, to reiterate, tailgate 26 is movable between at least two operative positions, a first generally vertically oriented stowed position with latches 27 each extending into its operatively associated opening 25, and, a second generally horizontally oriented deployed position with latches 27 disengaged from openings 25.

The tailgate construction explained above with respect to FIGS. 2 and 3 is widely used and well known with respect to pickup trucks. And, of course, as will be evident below, the tie down assembly of the invention is modifiable and adaptable to engage removably any desired tailgate latching system found or produced with respect to a pickup truck or other vehicle.

The improvements contemplated by the invention comprise a tie down assembly 50 removably mounted on the tailgate 16 of a pickup truck or other vehicle when said tailgate is in a generally horizontally oriented deployed position, although such a tie down assembly could be utilized on a tailgate regardless of the orientation of the tailgate. Such improvements are described below with reference to FIGS. 4 to 7.

In FIG. 4, latches 17 are, for sake of clarity, omitted from the ghost outline of tailgate 16.

Tie down assembly 50 illustrated in FIG. 4 includes elongate anchor member 51 with first 52 and second 53 ends. Anchor member 51 extends substantially from one end 20 of tailgate 16 to the other end 21 of tailgate 16. First 56 and second 57 bracket assemblies each are mounted on a different one of the first and second ends 52, 53 of elongate anchor member 51. Each of the bracket assemblies 56, 57 is shaped and dimensioned to engage detachably one of the jaws 18 of a tailgate latch 17. Specifically, each bracket assembly 56, 57 includes a pin 58A (comparable to outwardly extending pin 58) which extends inwardly and is shaped and dimensioned to be engaged by the jaws 18 of a latch 17. Jaws 18 typically are each inset in an end 20, 21 of a tailgate 16. The shape and dimension of bracket assembly 56 is equivalent to that of bracket assembly 57. When tie down assembly 50 is in the position illustrated in FIG. 4, pins 58A are engaged and disengaged in the same manner as pins 15, i.e., by manually operating handle 19 to open and close jaws 18.

Tie down anchor units 70, 71 are slidably mounted in said elongate anchor member. The shape and dimension of anchor unit 70 is equivalent to that of unit 71. The head 72 of each unit 70, 71 extends vertically upwardly through and slides along elongate slot 54 formed in anchor member 51. The foot 74 of each unit 70, 71 slides in and along the elongate orthogonal hollow 75 formed within anchor member 51. Aperture 73 formed in head 72 of each unit 70, 71 is shaped and dimensioned to receive the end 91, 92 of a tie down 90. A tie down 90 can comprise a rope, strap, bungee cord, wire, or any other member shaped and dimensioned to extend over and secure lumber, sheet rock, or any other material or object(s) carried in the bed of a pickup truck or other vehicle. When the load of lumber 100 or other material or object(s) has a height above floor 12 which is greater than the height of aperture 73 above the floor 12, then the tie down 90 will, in the manner suggested by the ghost outline of tie down 90 in FIG. 4, extend upwardly and—when tightened—generate on anchor unit force vectors extending in the direction of arrows B, C, and D in FIG. 4. The force vectors indicated by arrows C and D in FIG. 4 function to lift the foot 74 of anchor unit 70, 71 upwardly against the underside of the top 51A (FIG. 6) of anchor member 51. In one preferred embodiment of the invention, each anchor unit 70, 71 includes upwardly extending feet 78, 79 (FIG. 7) which are lifted upwardly by forces acting on anchor member 70 in the direction of arrow D. When feet 78, 79 are lifted upwardly in this manner they are frictionally received by an elongate slot 76, 77 which is formed in the top of member 51 and is generally parallel to the longitudinal axis of elongate member 51. The frictional engagement of feet 78, 79 with a slot 76, 77 functions to lock an anchor member 70 in position and to prevent movement of member 70 along member 51 in the direction of arrows E and F in FIG. 4. In another embodiment of the invention, feet 78, 79 are not formed on each member 70, and instead, the upper surfaces 80, 81 are, by the force generated in the direction of arrow D, pressed upwardly (in the direction of arrow D) against and frictionally engage the underside surface of the top 51A of member 51 to “lock” member 70 in fixed position in member 61.

As would be appreciated by those of skill in the art, the shape and dimension of each anchor member 70 and of member 51 can be varied as desired in order for member 70 and member 51 to engage to “lock” (frictionally or otherwise) an anchor member 70 in fixed position in member 51 when member 70 is upwardly displaced by a force vector acting in the direction of arrow D.

Bracket assembly 57A in FIG. 5 is identical to bracket assembly 57 except that pins 58 and 58A are eliminated and, in their place, orthogonal opening 82 is formed in bracket assembly 57A. When a tailgate assembly of the type illustrated in FIG. 2 is encountered, a pair of bracket assemblies 57A is utilized, each bracket assembly 57A replacing a different one of bracket assemblies 56 and 57. Consequently, as would be appreciated by those of skill in the art, openings 82 are each shaped and dimensioned to receive a latch 27 in the same manner that the opening in the latch bracket in a door frame receives the latch 27A (FIG. 3) of a door. Bracket assemblies 57A permit ready adaptation of tie down assembly 50 for use on a pickup truck with a tailgate of the kind illustrated in FIG. 2.

Inserts 84 (FIG. 8) are installed in each end of member 51 and include internally threaded apertures 85, 86 shaped to receive a pair of externally threaded fasteners 59 which extend through apertures 60 (FIG. 4) or 90 (FIG. 5) in a bracket assembly 57, 57A and which are used to secure the bracket assembly 57, 57A in place at each end of member 51. Inserts 84 can be permanently installed in member 51 by the use of welding, adhesive, etc., or, as illustrated in FIG. 8, can be removably adjustably inserted using a fastener 88 which extends through an aperture 89 into an aperture 87 which is in registration with aperture 89. The apparatus illustrated in FIG. 8 permits the operational length of member 51 to be adjusted by adjusting the distance the insert 84 extends outwardly from an end of member 51. Inserts 84 each extend only partially into each end of member 51 so that anchor units are free to slide along member 51 intermediate inserts 84.

Have described my invention in such terms as to enable those of skill in the art to understand and practice the invention, I claim:

1. In combination with a pickup truck comprising
a plurality of axles,
four ground engaging tires mounted on said axles,
a body,
a suspension operatively associated with said axles and said body,
said body including a bed comprising
a floor,
a pair of spaced apart side walls upwardly extending from said floor and each having a distal end,
a tailgate pivotally mounted on said bed and including a pair of spaced apart ends,
a pair of latches each mounted on a different end of said tailgate and shaped and dimensioned to engage detachable a different one of said distal ends of said side walls,
a handle mounted on said tailgate to disengage said latches from said distal ends of said side wall,
said tailgate movable between at least two operative positions,
a first generally vertically oriented stowed position with said latches engaging said distal ends of said side walls, and
a second generally horizontally oriented deployed position with said latches disengaged from said distal ends of said side walls,
the improvements comprising a tie down assembly removably mounted on said tailgate when said tailgate is in said second generally horizontally oriented deployed position, said tie down assembly including
(a) an elongate anchor member extending from one end of said tailgate to the other end of said tailgate, said anchor member including a first end and a second end spaced apart from said first end;
(b) first and second bracket assemblies each mounted on a different one of said first and second ends of said elongate anchor member, each of said bracket assemblies being shaped and dimensioned to engage detachably one of said tailgate latches such that said tailgate handle can be operated to release said first and second bracket assemblies from said tailgate latches;
(c) a plurality of tie down anchor units mounted in said elongate anchor member; and,
(d) at least one tie down extending from one tie down anchor unit to another tie down anchor unit.
